(19) United States
(12) Patent Application Publication
(10) Pub. No.: US 2017/0186248 A1
(43) Pub. Date: Jun. 29, 2017

(54) SYSTEM AND METHOD TO IDENTIFY ENGAGEMENT OF VEHICLE AUTOMATION FUNCTIONS

(71) Applicant: Opus Inspection, Inc., East Granby, CT (US)

(72) Inventors: Thomas J. Fournier, Tucson, AZ (US); Lothar Geilen, Key Biscayne, FL (US); Brian J. Herron, Dexter, MI (US)

(21) Appl. No.: 15/391,297

(22) Filed: Dec. 27, 2016

Related U.S. Application Data
(60) Provisional application No. 62/271,397, filed on Dec. 28, 2015.

(51) Int. Cl. G07C 5/00; G01S 19/14; G05D 1/00

(52) U.S. Cl. CPC G07C 5/008; G05D 1/0088; G01S 19/14

(57) ABSTRACT

A system and method for monitoring operation of vehicle automation systems utilizes an electronic vehicle monitor configured to connect to a computer system of a vehicle via the on board diagnostics (“OBD”) port of the vehicle. The electronic vehicle monitor is configured to obtain operational status information of the activation or use of vehicle automation systems of the vehicle, such as of an automated braking system, automated acceleration system, automated steering system, automated vehicle navigation system, automated collision avoidance system, and an automated cruise control system. The electronic vehicle monitor transmits the obtained operational status information to a computing device, such as a mobile computer of a passenger or the vehicle driver, or to a remotely located computer. The electronic vehicle monitor may include a wireless transmitter, and may include a global positioning system module or be configured to obtain location information from a global positioning system of the vehicle

### CROSS REFERENCE TO RELATED APPLICATION

The present application claims priority of U.S. provisional application Ser. No. 62/271,397 filed Dec. 28, 2015, which is hereby incorporated herein by reference in its entirety.

### BACKGROUND OF THE INVENTION

The present invention is directed to a system and method for identifying engagement of vehicle driver automation functions, and in particular is directed for use in connection with enabling individuals and entities, such as passengers, vehicle owners, and vehicle fleet managers, to know, monitor and/or record when and what vehicle driver automation functions are engaged for a given vehicle.

Traditionally vehicles have not included automation functions such that operation of the vehicle has been entirely dependent upon the driver. Various levels of vehicle automation are progressively being developed and employed, whereby selected vehicle operation functions may be undertaken by systems of the vehicle independent of the driver. These driver assistance systems include technology that senses other vehicles, pedestrians and/or objects exterior of the vehicle, including in front of the vehicle when being driven, and operate to assist or control vehicle systems, including such as braking and steering controls. Accordingly, various levels of semiautonomous and autonomous driver assist systems are thus provided.

The National Highway Traffic Safety Administration (“NHTSA”), which is an agency of the U.S. government, has defined five levels of on road vehicle automation, which can be generally summarized as follows: Level 0—no automated functions; Level 1—limited automation that allows either both hands or both feet to disengage from physically operating the controls, but not disengagement of hands and feet together; Level 2—limited automation may enable a driver to simultaneously remove their hands form the steering wheel and feet from the pedals, with the driver being required to resume control in response to traffic signs and signals, route changes, and the like; Level 3—increased automation functions whereby a destination may be entered into a vehicle control system, with the vehicle navigating, steering, accelerating and braking the vehicle, including in response to traffic signs and signals and the detection of traffic, pedestrians and objects, but with a driver required to be present for potentially taking control of the vehicle in response to factors that degrade the ability of the vehicle to operate autonomously, such as weather or particular traffic occurrences; Level 4—fully autonomous operation of a vehicle without requiring any control inputs from a driver such that a trip is conducted without human intervention or assistance other than input of destination or navigation information.

### SUMMARY OF THE INVENTION

The present invention provides a system and method for automatically monitoring, reporting, and/or recording the engagement of vehicle automation functions.

According to an aspect of the present invention, a system for monitoring operation of vehicle automation systems comprises an electronic vehicle monitor configured to connect to a vehicle computer system through an on board diagnostics (“OBD”) port of the vehicle, with the electronic vehicle monitor configured to obtain operational status information of the activation or use of the vehicle automation systems. The electronic vehicle monitor is configured to transmit the obtained operational status information to a computing device, such as to a mobile computer of a driver or passenger, or to a remotely located computer.

In a particular embodiment, the electronic vehicle monitor includes a wireless transmitter, and may include a global positioning system module or be configured to obtain geographic locational information from a global positioning system of the vehicle.

According to another aspect of the present invention, a method of monitoring operation of vehicle automation systems comprises providing an electronic vehicle monitor configured to obtain operational status information of the activation or use of vehicle automation systems, with the electronic vehicle monitor including an on board diagnostics (“OBD”) connector for connecting to an OBD port of a vehicle. The method further includes operatively connecting the electronic vehicle monitor to a vehicle, obtaining operational status information of vehicle automation systems using the electronic vehicle monitor, and transmitting the operational status information to a computing device.

In particular embodiments, the method includes obtaining the engagement status of at least one of an automated braking system, automated acceleration system, automated steering system, automated vehicle navigation system, automated collision avoidance system, and an automated cruise control system. The method may further include wirelessly transmitting the operational status information, and include obtaining geographic locational information of the vehicle.

The system and method of the present invention enables passengers, vehicle owners and drivers, as well as vehicle fleet managers, to know when, how, and to what extent vehicle automation systems are engaged and being utilized. The information may be used to coordinate with particular preferences for use of the systems, such as by a passenger, as well as to monitor compliance with policies established by fleet managers, operators of ride share services, insurance companies, and the like. The information may further be used to document the status of the employment of vehicle automation systems at the time of accidents or traffic incidents.

These and other objects, advantages, purposes and features of this invention will become apparent upon review of the following specification in conjunction with the drawings.

### BRIEF DESCRIPTION OF THE DRAWINGS

FIG. 1 is a schematic illustration of a vehicle driver automation engagement identification system in accordance with an aspect of the present invention disclosing a vehicle equipped with an electronic device for monitoring and reporting engagement of vehicle driver automation systems.

### DESCRIPTION OF THE PREFERRED EMBODIMENTS

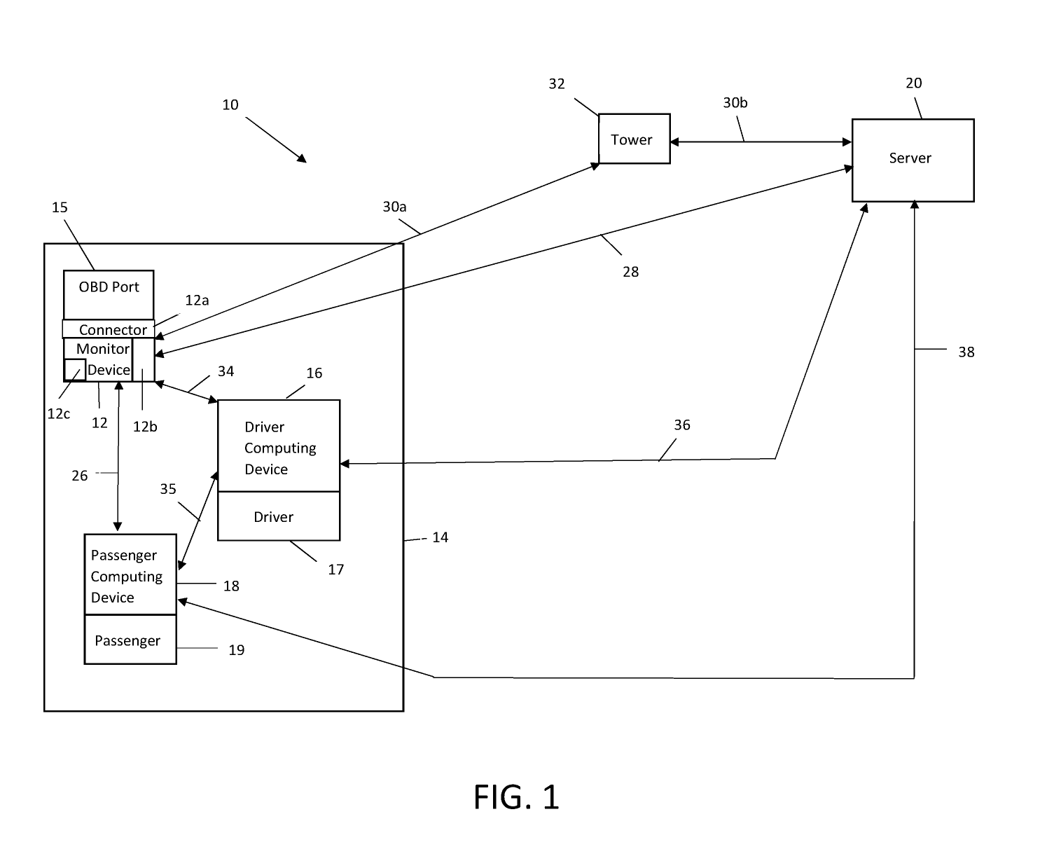

The present invention will now be described with reference to the accompanying figure, wherein the numbered elements in the following written description correspond to like-numbered elements in the figure. A monitoring system in accordance with an embodiment of the present invention is schematically illustrated at 10 in FIG. 1, where system 10 is used to monitor and report the status of the use of the driver assistance systems of vehicle 14, including to identify when, where, and/or what driver assistance systems are utilized during operation of vehicle 14. As there shown, an electronic vehicle automation monitor device 12 is operatively connected to vehicle 14, where in the illustrated embodiment device 12 includes an On Board Diagnostics (“OBD”) connector 12a to connect to an OBD port 15 of vehicle 14. Device 12 operates to interrogate the computer system of vehicle 14 to obtain information regarding the operational status of the driver assistance or vehicle automation systems of the vehicle 14, such as automated braking systems, steering systems, navigating systems, cruise control systems, and the like, which systems may be selectively activated or deactivated for use by the vehicle operator. Device 12 additionally transmits the operational status information obtained to one or more of various computing devices, such as smartphones, tablets, servers, or the like. A number of such computing devices are shown in the illustrated embodiment, including a driver computing device 16, a passenger computing device 18, and a remote computing device configured as a server 20, such as may be maintained by a fleet operator. As discussed in more detail below, individuals or entities, such as passengers or vehicle fleet managers, may thus obtain the operational status information of the use of the automation systems of vehicle 14. This information may be used, for example, to coordinate the operation of vehicle 14 to the preferences of a passenger 19, or to monitor the settings employed by a driver 17 during operation of vehicle 14, including as to what systems are being used, as well as when and where those systems are used.

In accordance with an aspect of the present invention, electronic vehicle automation monitor device 12 is operatively connected to vehicle 14 through the OBD port 15 of vehicle 14, with electronic device 12 including both hardware and software. Device 12 operates to interrogate vehicle 14 to obtain the status of the use of the various vehicle automation systems of vehicle 14, where the computer control system of vehicle 14 includes information regarding the operation of the automation systems and is accessible via OBD port 15. This includes, for example, which of the various equipped vehicle driver automation systems are activated or deactivated. For example, device 12 is able to detect and transmit whether automated systems such as an automated braking system, steering system, navigating system, cruise control system, or the like, are activated or deactivated. Device 12 further operates to wirelessly transmit the status information to one or more computing devices via a wireless transmitter 12b of device 12. This may include, for example, transmitting the status information to a remote server 20, the passenger computing device 18, and/or the driver computing device 16. Additionally or alternatively, upon device 12 communicating status information to driver computing device 16, device 16 may re-transmit the status information to the server 20.

These various information transmissions are illustrated in FIG. 1, with the transmission from electronic device 12 to passenger computing device 18 illustrated as signal 26, and the transmission from electronic device 12 to server 20 illustrated as signal 28. Alternatively, electronic device 12 may transmit a signal 30a to a transmission tower 32, with tower 32 in turn transmitting the signal 30b to server 20. In such an embodiment, tower 32 may comprise a cellular tower or base station Still further, the transmission from electronic device 12 to driver computing device 16 is illustrated as signal 34, with the subsequent transmission of the status information from driver computing device 16 to server 20 illustrated as signal 36. In an alternative embodiment, passenger computing device 18 may operate to re-transmit status information to server 20 such as via signal 38, and/or driver computing device 16 may also operate to re-transmit status information to the passenger computing device 18, such as illustrated by signal 35.

It should be appreciated that various means of signal transmission may be employed within the scope of the present invention. This may include, for example, Blue Tooth, or a wireless local area network (“WLAN”) or Wi-Fi, or other such communication protocols or transmission systems, including combinations thereof. For example, Blue Tooth may be used to communicate from electronic device 12 to the driver computing device 16, with the driver computing device 16 in turn communicating to server 20 via Wi-Fi. It should also be appreciated that the various computing devices discussed above employ application software for communicating and processing the various signals in accordance with the present invention.

Electronic device 12 may be provided with a global positioning system (“GPS”), such as a GPS module 12c that may be configured as a GPS chip and associated software, to correlate locational information with the status information of the use of the vehicle automation systems. Locational information may be additionally or alternatively provided by way of the driver computing device 16 or passenger computing device 18, such as the GPS data from a computing device being collected along with the collection of the operational status information from OBD port 15. Still further, locational information may be obtained via a GPS system of the vehicle, including, for example, where such information is provided to the vehicle computer system such that it is accessible via OBD port 15. The operational status of the vehicle automation systems acquired through OBD port 15 by electronic device 12 may thus be additionally provided, transmitted and recorded with vehicle location, speed, time, weather and road conditions, for example.

The status information of the systems may be utilized by individuals or entities for various purposes. For example, in the case of a passenger 19 being transported by vehicle 14, where vehicle 14 may be associated with a taxi operator or a ride share program, the passenger 19 may have particular preferences for operation of vehicle 14 in connection with its various vehicle driver automation systems. Particular passengers may prefer that a vehicle be operated utilizing all available vehicle driver automation systems as much as possible to avoid human error. Alternatively, other passengers may prefer less or no reliance on such vehicle driver automation systems, or only selected systems, preferring not to rely on automated systems during transport. System 10 may thus be employed to provide passenger 19 with information regarding the operational state of the vehicle driver automation functions of vehicle 14. Passenger 19 may then elect to advise driver 17 regarding the preferences of passenger 19 regarding the use of such systems. In a particular embodiment, the preferences of passenger 19 may be recorded on computing device 18 with computing device 18 transmitting notification of such preferences to the computing device 16 of driver 17, such as via a transmission signal 35.

Still further, in the case of entities or individuals that are not driving vehicle 14, such as a fleet operator, including taxi service providers, package delivery services, or other transport service providers, including ride share service provider organizations, may employ system 10 to monitor and record use of the automation systems of a vehicle. Such information may be used for monitoring compliance with policies for use of the equipped vehicle automation systems. For example, a fleet operator may specify times that automated systems are either required to be or prohibited from being used, specify that automated systems are required to be employed in particular geographical locations or on particular roads and/or specify use of particular ones of the available vehicle automation systems. This information may be transmitted, such as to a remote sever 20, with the information being to a fleet operator in near real time for monitoring purposes, or may enable compiled reports to be created and provided with respect to particular vehicles and operators. The use of the vehicle automation systems may be further relevant to a fleet operator for liability purposes, such as to prove compliance with proper operation of the vehicle. System 10 may also be employed by individuals or entities that do not operate the vehicles, but instead have an interest in the operation of the vehicle, including insurance companies or regulatory bodies. It should be appreciated that in the context of a fleet operator, such as a package delivery service provider, it would thus not be required that there be a passenger and passenger computing device.

It should also be appreciated that the driver computing device 16 may be a smartphone, tablet, laptop computer, or other such portable computing device. Similarly, the passenger computing device 18 may be a smartphone, tablet, portable or desktop computer, or other such device. It should further be appreciated that the SPO computing device, which in the illustrated embodiment is shown as SPO server 20, may comprise one or more computing devices, as well as computing devices other than servers. Changes and modifications in the specifically described embodiments can be carried out without departing from the principles of the present invention which is intended to be limited only by the scope of the appended claims, as interpreted according to the principles of patent law including the doctrine of equivalents.

The embodiments of the invention in which an exclusive property or privilege is claimed are defined as follows:

1. A system for monitoring operation of vehicle automation systems comprising:
an electronic vehicle monitor configured to connect to a vehicle computer system of a vehicle, said electronic vehicle monitor configured to obtain operational status information of the activation or use of vehicle automation systems of the vehicle;
said electronic vehicle monitor configured to transmit the obtained operational status information to a computing device.

2. The system of claim 1, wherein said electronic vehicle monitor includes an on board diagnostics (“OBD”) connector for connecting to an OBD port of the vehicle.

3. The system of claim 1, wherein said electronic vehicle monitor is configured to obtain operational status information of vehicle automation systems comprising at least one of an automated braking system, automated acceleration system, automated steering system, automated vehicle navigation system, automated collision avoidance system, and an automated cruise control system.

4. The system of claim 1, wherein the operational status information obtained by said electronic vehicle monitor comprises the engagement status of vehicle automation systems of the vehicle.

5. The system of claim 1, wherein said electronic vehicle monitor includes a global positioning system module.

6. The system of claim 1, wherein said electronic vehicle monitor includes a wireless transmitter.

7. The system of claim 1, wherein the computing device comprises at least one of (i) a remote computing device, (ii) a computing device of a passenger of the vehicle, and (iii) a computing device of a driver of the vehicle.

8. The system of claim 7, wherein the remote computing device comprises a server.

9. The system of claim 7, wherein the computing device of the passenger and/or the driver comprises a mobile computing device.

10. The system of claim 1, wherein said electronic vehicle monitor is configured to obtain geographic locational information from the vehicle computer system.

11. A method of monitoring operation of vehicle automation systems comprising:
providing an electronic vehicle monitor configured to obtain operational status information of the activation or use of vehicle automation systems of a vehicle;
operatively connecting the electronic vehicle monitor to a vehicle;
obtaining operational status information of vehicle automation systems of the vehicle using the electronic vehicle monitor; and
transmitting the operational status information from said electronic vehicle monitor to a computing device.

12. The method of claim 11, wherein said electronic vehicle monitor including an on board diagnostics (“OBD”) connector for connecting to an OBD port of a vehicle;

13. The method of claim 11, wherein said obtaining operational status information of vehicle automation systems comprises obtaining operational status information of vehicle automation systems comprising at least one of an automated braking system, automated acceleration system, automated steering system, automated vehicle navigation system, automated collision avoidance system, and an automated cruise control system.

14. The method of claim 12, wherein the operational status information obtained by said electronic vehicle monitor comprises the engagement status of vehicle automation systems of the vehicle.

15. The method of claim 11, wherein said transmitting the operational status information comprises wirelessly transmitting the operational status information.

16. The method of claim 11, further including obtaining geographic locational information of the vehicle.

17. The method of claim 16, wherein said obtaining geographic locational information of the vehicle comprises using said electronic vehicle module to obtain geographic locational information.

18. The method of claim 17, wherein said electronic vehicle monitor includes a global positioning system module.

19. The method of claim 17, wherein said using said electronic vehicle module to obtain geographic locational information comprises obtaining geographic locational information from a global positioning system of the vehicle.

20. The method of claim 11, wherein the computing device comprises at least one of (i) a remote computing device, (ii) a computing device of a passenger of the vehicle, and (iii) a computing device of a driver of the vehicle.

21. The method of claim 20, wherein the remote computing device comprises a server.

22. The method of claim 20, wherein the computing device of the passenger and/or the driver comprises a mobile computing device.
